(19) United States
(12) Patent Application Publication
(10) Pub. No.: US 2008/0192403 A1
(43) Pub. Date: Aug. 14, 2008

(54) Static electricity neutralizer

(76) Inventor: Pin Kuang Chen, Rowand Heights, CA (US)

Correspondence Address: DAVID AND RAYMOND PATENT FIRM, 108 N. YNEZ AVE., SUITE 128, MONTEREY PARK, CA, 91754, US

(21) Appl. No.: 11/704,630

(22) Filed: Feb. 9, 2007

(51) Int. Cl. H05F 3/04

(52) U.S. Cl. 361/220

(57) ABSTRACT

A method of dissipating static electricity for a charged object includes the steps of electrically connecting an electrostatic probe with an electric terminal of an electrostatic dissipater; contacting the electrostatic probe with the charged object for electrically conducting the charged object with the electrostatic dissipater through the electric terminal and the electrostatic probe to form a electrostatic dissipation circuit, wherein when the charged object possess static electricity, the static electricity is in electric connection with the electrostatic probe; and diverting the static electricity of the charged object to the electrostatic dissipater through the electrostatic probe and the electric terminal, wherein the electrostatic dissipater converts the electrostatic energy into another predetermined form of energy as consumption of the static electricity so as to eliminate the static electricity of the charged object through the electrostatic dissipation circuit.

### BACKGROUND OF THE PRESENT INVENTION

1. Field of Invention

The present invention relates to a portable accessory, and more particularly to a method of dissipating static electricity on a charged object for avoiding minor electrostatic shocks.

2. Description of Related Arts

Static electricity is known as a stationary electric charge, typically produced by friction, which causes sparks or crackling or the attraction of dust or hair. It is a unique physical phenomenon which exists when the number of electrons and positive ions on an outer surface of a physical object is unbalanced. When a person touches the object in which static electricity exist, he or she may get minor electrostatic shock in the form of a little spark generated at the person's skin. Very often, when the person touches the object with his or her fingers, such as when the person is opening a door of his or her car, he or she may get hurt by the spark resulting from static electricity.

Over time, various sorts of devices and strategies for preventing electrostatic shocks or for avoiding static electricity from forming have been developed. They are designed for use in a wide variety of circumstances. For example, there exist specially designed protective covers for objects so as to prevent formation of static electricity on the outer surface of that object. Second, in some circumstances, the relative humidity of the environment in which the object is to be operated or stored can be controlled to achieve an optimal level of static electricity of the object. Third, people may wear specifically designed clothing which is capable of conducting electricity for diverting the static electricity present on the wearer' body. All these are well known as conventional methods or strategies for preventing minor electrostatic shocks.

There are, however, limitations for these conventional strategies. First, it seems that the above-mentioned strategies involve elimination or minimization of static electricity in particular circumstances for particular purposes. There are no strategies for general prevention of neutralizing static electricity in daily life. For example, while it is true that adjusting the humidity of the environment in which the objects are stored or operated would effectively control emergence of static electricity on the surface of those objects in question, it is not generally true that ordinary people could manipulate relative humidity at will. It seems that there is no way to manipulate relative humidity in outdoor environment.

Second, all of the above strategies involve relatively expensive equipments and are simply not affordable for most individuals. For example, the cost for varying relative humidity in confined areas could be very high depending on the performance of the adjustment. Although a simple air conditioning system will do in some circumstances, others may involve sophisticated electrical appliances or equipments for achieve a desirable humidity.

Third, wearing clothes which conduct electricity can be very dangerous, and this strategy is obviously not for everyone, especially for children and untrained persons. More importantly, these clothes are usually designed for specific purposes, such as particular scientific experiments, and they are certainly not designed for daily use.

### SUMMARY OF THE PRESENT INVENTION

A main charged object of the present invention is to provide a method of dissipating static electricity for a charged object, wherein the method can be conveniently employed in a handy accessory so that individuals may eliminate or dissipate static electricity conveniently and rapidly without recourse to expensive or complicated equipments.

Another charged object of the present invention is to provide a method of dissipating static electricity for a charged object, wherein the method comprises the steps of diverting static electricity to a electrostatic dissipater which is capable of converting the energy carried by the static electricity into another form of energy, such as light energy and heat energy, for the purpose of substantially eliminating static electricity on the charged objects.

Another charged object of the present invention is to provide a method of naturalizing static electricity between a charged object and a user so as to substantially avoid minor electrostatic shocks in daily life for the users of the present invention.

Another charged object of the present invention is to provide a method of dissipating static electricity for a charged object, wherein the method could be utilized and carried in corporation with a wide variety of personal accessories so as to allow widespread use of the present invention.

Accordingly, in order to accomplish the above charged objects, the present invention provides a method of dissipating static electricity for a charged object, comprising the steps of:

(a) electrically connecting an electrostatic probe with an electric terminal of an electrostatic dissipater;

(b) contacting the electrostatic probe with the charged object for electrically conducting the charged object with the electrostatic dissipater through the electric terminal and the electrostatic probe, wherein when the charged object possess static electricity, the static electricity is in electric connection with the electrostatic probe; and

(c) diverting the static electricity of the charged object to the electrostatic dissipater through the electrostatic probe and the electric terminal, wherein the electrostatic dissipater is arranged to convert the electrostatic energy into another predetermined form of energy as consumption of the static electricity so as to eliminate the static electricity of the charged object.

Moreover, the present invention also provides a method of naturalizing static electricity between a charged object and a user, comprising the steps of:

(a) contacting an electrostatic probe with the charged object;

(b) electrically conducting the electrostatic probe with an electric terminal of an electrostatic dissipater; and

(c) generating an indicating signal by the electrostatic dissipater when the static electricity of the charged object is removed.

These and other charged objectives, features, and advantages of the present invention will become apparent from the following detailed description, the accompanying drawings, and the appended claims.

### BRIEF DESCRIPTION OF THE DRAWINGS

FIG. 1 is a perspective view of an electrostatic dissipater according to a preferred embodiment of the present invention.

FIG. 2 is sectional side view of an electrostatic dissipater according to the above preferred embodiment of the present invention.

FIG. 3 is a method of dissipating static electricity for a charged object according to the above preferred embodiment of the present invention.

### DETAILED DESCRIPTION OF THE PREFERRED EMBODIMENT

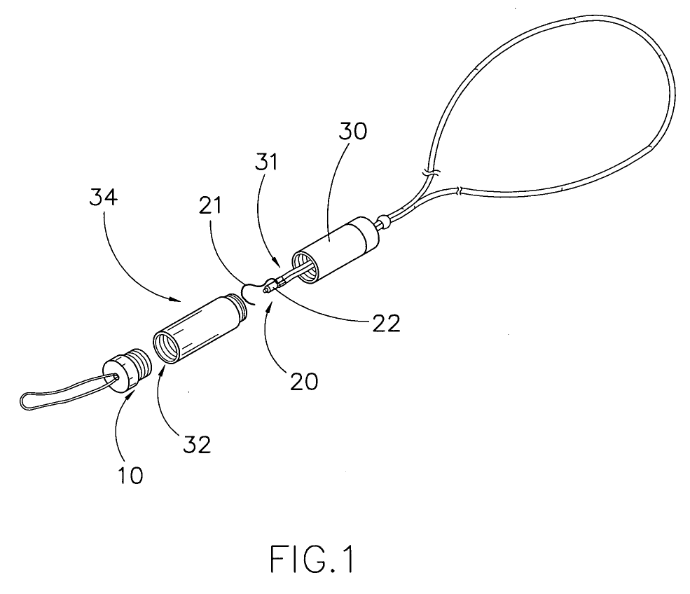

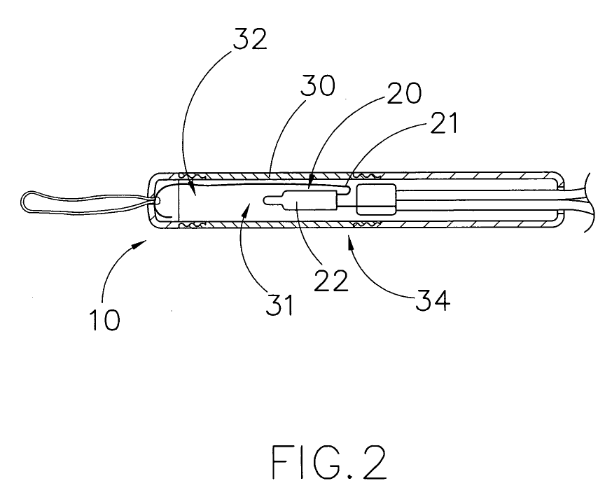

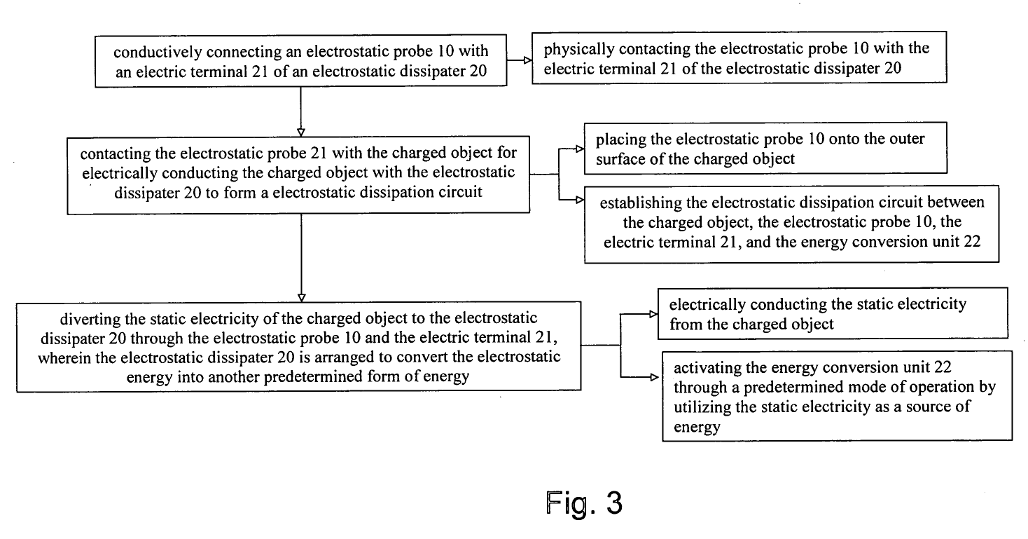

Referring to FIG. 1 to FIG. 3 of the present invention, a method of dissipating static electricity for a charged object according to a preferred embodiment of the present invention is illustrated, in which the method comprises the steps of:

(a) conductively connecting an electrostatic probe 10 with an electric terminal 21 of an electrostatic dissipater 20;

(b) contacting the electrostatic probe 10 with the charged object for electrically conducting the charged object with the electrostatic dissipater 20 through the electric terminal 21 and the electrostatic probe 10 to form a electrostatic dissipation circuit between the charged object and the electrostatic dissipater 20, wherein when the charged object possess static electricity, the static electricity is in electric connection with the electrostatic probe 10; and

(c) diverting the static electricity of the charged object to the electrostatic dissipater 20 through the electrostatic probe 10 and the electric terminal 21, wherein the electrostatic dissipater 20 is arranged to convert the electrostatic energy into another predetermined form of energy as consumption of the static electricity so as to eliminate the static electricity of the charged object through the electrostatic dissipation circuit.

According to the preferred embodiment of the present invention, electrostatic probe 10 is made of metallic materials having excellent electric conductivity, and is shaped and sized to have a predetermined cross section for being conveniently incorporated with the electrostatic dissipater 20, and carried by a user of the present invention.

The electrostatic dissipater 20 comprises an energy conversion unit 22, and the electric terminal 21 electrically extended from the energy conversion unit 22 for electrically connecting with the electrostatic probe 10 in such a manner that when the electrostatic probe 10 is in touch with the charged object having static electricity, the static electricity is conducted from the charged object to the electrostatic probe 10 and finally to the energy conversion unit 22 through the electric terminal. According to the preferred embodiment of the present invention, the energy conversion unit 22 is an electrical appliance, and a LED in this particular embodiment, for converting the electrical energy carried in the static electricity into light energy, and possibly a little heat energy.

Step (a) comprises the step (a.1) of physically contacting the electrostatic probe 10 with the electric terminal 21 of the electrostatic dissipater 20 so as to provide a path by which the static electricity can be transmitted as part of the electrostatic dissipation circuit. In order to facilitate easy handling and convenient use of the present invention, the electrostatic probe 10 and the electrostatic dissipater 20 can be mounted into a compact and handy housing. Thus, the method of dissipating static electricity further comprises the steps, before step (a), of:

(1) providing a compact accessory housing 30 having a receiving cavity 31, and a front opening 32 communicating with the receiving cavity 31; and

(2) mounting the electrostatic dissipater 20 into the receiving cavity 31; and

(3) mounting the electrostatic probe 10 at the front opening 32 of the accessory housing 30, in such a manner that the electrostatic probe 10 is adapted to electrically connect with the electrostatic dissipater 20 within the receiving cavity 31.

Step (b) comprises the steps of:

(b.1) placing the electrostatic probe 10 onto the outer surface of the charged object so as to make a physical contact the electrostatic probe 10 with the charged object; and

(b.2) establishing the electrostatic dissipation circuit between the charged object, the electrostatic probe 10, the electric terminal 21, and the energy conversion unit 22. Note that the electrostatic dissipation circuit can be established by ensuring proper electrical conduction between the charged object and the energy conversion unit 22 through the electrostatic probe 10 and the electric terminal 21 of the electrostatic dissipater 20.

In the step (c), the electrostatic dissipater 20 is self-activated when the electrostatic probe 10 is in contact with the charged object to discharge the static electricity of the charged object.

Step (c) comprises the steps of:

(c.1) electrically conducting the static electricity from the charged object to the energy conversion unit 22 of the electrostatic dissipater 20 through the electrostatic dissipation circuit; and

(c.2) activating the energy conversion unit 22 through a predetermined mode of operation by utilizing the static electricity as a source of energy, such that the static electricity is substantially consumed to power up the predetermined mode of operation for eliminating the static electricity on the charged object.

As mentioned earlier, the predetermined mode of operation of the energy conversion unit 22 is an illumination of the LED, so that the static electricity as collected by the electrostatic dissipation circuit is consumed in the sense that the electrostatic energy is transformed to light energy, as well as a small amount of heat energy.

Thus, the electrostatic dissipater 20 comprises a LED having a first terminal as the electric terminal 21 electrically coupling with the electrostatic probe 10 such that when the electrostatic probe 10 is in contact with the charged object, the LED converts the electrostatic energy into the light energy so as to ensure the static electricity being discharged from the charged object after a light of the LED is dismissed.

It is worth mentioning that the method further comprises a step of providing a finger-sized accessory housing 30 which is made of insulated material to support the electrostatic dissipater 20 in the accessory housing 30 and to retain the electrostatic probe 10 at a position that the electrostatic probe 10 is mounted to an end of the accessory housing 30 such that the accessory housing 30 is adapted to be held to controllably adjust the electrostatic probe 10 in contact with the charged object.

In light of the above disclosure, and without adding any new inventive concept, the present invention also provides a method of naturalizing static electricity between a charged object and a user, comprising the steps of:

(a′) providing a finger-sized accessory housing 30 for being held by the user;

(b′) contacting an electrostatic probe 10 with the charged object, wherein the electrostatic probe 10 is provided at one end of the accessory housing 30;

(c′) electrically conducting the electrostatic probe 10 with an electric terminal 21 of an electrostatic dissipater 20, wherein the electrostatic dissipater 20 is disposed in the accessory housing 30; and

(d′) generating an indicating signal by the electrostatic dissipater 20 when the static electricity of the charged object is discharged.

Step (c′) further comprises a step of forming an electrostatic dissipation circuit between the charged object and the electrostatic dissipater 20 to consume the static electricity as a power source of the electrostatic dissipater 20 to generate the indicating signal so as to eliminate the static electricity of the charged object through the electrostatic dissipation circuit.

In step (d′), the indicating signal is a light signal that when the electrostatic dissipater 20 converts the electrostatic energy into a light energy.

According to the preferred embodiment of the present invention, the electrostatic dissipater 20 comprises a LED having a first terminal as the electric terminal 21 electrically coupling with the electrostatic probe 10, and a second terminal contacting with an inner wall of the accessory housing 30, such that when the electrostatic probe 10 is in contact with the charged object, the LED is powered by the electrostatic energy to generate the indicating signal so as to ensure the static electricity being discharged from the charged object after a light of the LED is dismissed.

The accessory housing 30 is made of insulated material, and has a receiving cavity 31 receiving the LED therein, a front opening 32 communicating with the receiving cavity 31 to mount the electrostatic probe 10 at the front opening 32 to contact with the first terminal of the LED, and a transparent window 34 aligned with the LED for the light of the LED passing through the transparent window 34.

The accessory housing 30 is meant to be handy so that the user can carry it conveniently. Thus, the accessory housing 30 further comprises carrying means for the user carrying the accessory housing 30 on a body of the user. The carrying means may be embodied as a string.

Step (c′) comprises the steps of:

(c.1′) placing the electrostatic probe 10 onto the outer surface of the charged object so as to make a physical contact the electrostatic probe 10 with the charged object; and

(c.2′) establishing the electrostatic dissipation circuit between the charged object, the electrostatic probe 10, the electric terminal 21, and the energy conversion unit 22. Note that the electrostatic dissipation circuit can be established by ensuring proper electrical conduction between the charged object and the energy conversion unit 22 through the electrostatic probe 10 and the electric terminal 21 of the electrostatic dissipater 20.

Step (d′) comprises the step of activating the energy conversion unit 22 through a predetermined mode of operation by utilizing the static electricity as a source of energy, such that the static electricity is substantially consumed to power up the predetermined mode of operation for eliminating the static electricity on the charged object. As mentioned earlier, the mode of operation is illumination of the energy conversion unit 22, which is preferably a LED.

One skilled in the art will understand that the embodiment of the present invention as shown in the drawings and described above is exemplary only and not intended to be limiting.

It will thus be seen that the charged objects of the present invention have been fully and effectively accomplished. It embodiments have been shown and described for the purposes of illustrating the functional and structural principles of the present invention and is subject to change without departure from such principles. Therefore, this invention includes all modifications encompassed within the spirit and scope of the following claims.

What is claimed is:

1. A method of dissipating static electricity from a charged object, comprising the steps of:
(a) conductively connecting an electrostatic probe with an electric terminal of an electrostatic dissipater;
(b) contacting said electrostatic probe with said charged object for electrically conducting said charged object with said electrostatic dissipater through said electric terminal and said electrostatic probe to form an electrostatic dissipation circuit between said charged object and said electrostatic dissipater, wherein when said charged object possess static electricity, said static electricity is in electrical connection with said electrostatic probe; and
(c) diverting said static electricity of said charged object to said electrostatic dissipater through said electrostatic probe and said electric terminal, wherein said electrostatic dissipater converts said electrostatic energy into another predetermined form of energy as consumption of said static electricity so as to eliminate said static electricity of said charged object through said electrostatic dissipation circuit.

2. The method, as recited in claim 1, wherein the step (a) comprises a step of physically contacting said electrostatic probe with said electric terminal of said electrostatic dissipater to provide a path for transmitting said static electricity in said electrostatic dissipation circuit.

3. The method as recited in claim 1 wherein, in the step (c), said electrostatic dissipater is self-activated when said electrostatic probe is in contact with said charged object to discharge said static electricity of said charged object.

4. The method as recited in claim 2 wherein, in the step (c), said electrostatic dissipater is self-activated when said electrostatic probe is in contact with said charged object to discharge said static electricity of said charged object.

5. The method as recited in claim 1 wherein, in the step (c), further comprising a step of converting said electrostatic energy into light energy, wherein said electrostatic dissipater comprises a LED having a first terminal as said electric terminal electrically coupling with said electrostatic probe such that when said electrostatic probe is in contact with said charged object, said LED converts said electrostatic energy into said light energy so as to ensure said static electricity being discharged from said charged object after a light of said LED is dismissed.

6. The method as recited in claim 2 wherein, in the step (c), further comprising a step of converting said electrostatic energy into light energy, wherein said electrostatic dissipater comprises a LED having a first terminal as said electric terminal electrically coupling with said electrostatic probe such that when said electrostatic probe is in contact with said charged object, said LED converts said electrostatic energy into said light energy so as to ensure said static electricity being discharged from said charged object after a light of said LED is dismissed.

7. The method as recited in claim 4 wherein, in the step (c), further comprising a step of converting said electrostatic energy into light energy, wherein said electrostatic dissipater comprises a LED having a first terminal as said electric terminal electrically coupling with said electrostatic probe such that when said electrostatic probe is in contact with said charged object, said LED converts said electrostatic energy into said light energy so as to ensure said static electricity being discharged from said charged object after a light of said LED is dismissed.

8. The method, as recited in claim 1, further comprising a step of providing a finger-sized accessory housing which is made of insulated material to support said electrostatic dissipater in said accessory housing and to retain said electrostatic probe at a position that said electrostatic probe is mounted to an end of said accessory housing such that said accessory housing is adapted to be held to controllably adjust said electrostatic probe in contact with said charged object.

9. The method, as recited in claim 4, further comprising a step of providing a finger-sized accessory housing which is made of insulated material to support said electrostatic dissipater in said accessory housing and to retain said electrostatic probe at a position that said electrostatic probe is mounted to an end of said accessory housing such that said accessory housing is adapted to be held to controllably adjust said electrostatic probe in contact with said charged object.

10. The method, as recited in claim 7, further comprising a step of providing a finger-sized accessory housing which is made of insulated material to support said electrostatic dissipater in said accessory housing and to retain said electrostatic probe at a position that said electrostatic probe is mounted to an end of said accessory housing such that said accessory housing is adapted to be held to controllably adjust said electrostatic probe in contact with said charged object.

11. A method of naturalizing static electricity between a charged object and a user, comprising the steps of:
(a) providing a finger-sized accessory housing for being held by said user;
(b) contacting an electrostatic probe with said charged object, wherein said electrostatic probe is provided at one end of said accessory housing;
(c) electrically conducting said electrostatic probe with an electric terminal of an electrostatic dissipater, wherein said electrostatic dissipater is disposed in said accessory housing; and
(d) generating an indicating signal by said electrostatic dissipater when said static electricity of said charged object is discharged.

12. The method as recited in claim 11 wherein the step (c) further comprises a step of forming an electrostatic dissipation circuit between said charged object and said electrostatic dissipater to consume said static electricity as a power source of said electrostatic dissipater to generate said indicating signal so as to eliminate said static electricity of said charged object through said electrostatic dissipation circuit.

13. The method as recited in claim 11 wherein, in the step (d), said indicating signal is a light signal that when said electrostatic dissipater converts said electrostatic energy into a light energy.

14. The method as recited in claim 12 wherein, in the step (d), said indicating signal is a light signal that when said electrostatic dissipater converts said electrostatic energy into a light energy.

15. The method, as recited in claim 13, wherein said electrostatic dissipater comprises a LED having a first terminal as said electric terminal electrically coupling with said electrostatic probe and a second terminal contacting with an inner wall of said accessory housing, such that when said electrostatic probe is in contact with said charged object, said LED is powered by said electrostatic energy to generate said indicating signal so as to ensure said static electricity being discharged from said charged object after a light of said LED is dismissed.

16. The method, as recited in claim 14, wherein said electrostatic dissipater comprises a LED having a first terminal as said electric terminal electrically coupling with said electrostatic probe and a second terminal contacting with an inner wall of said accessory housing, such that when said electrostatic probe is in contact with said charged object, said LED is powered by said electrostatic energy to generate said indicating signal so as to ensure said static electricity being discharged from said charged object after a light of said LED is dismissed.

17. The method, as recited in claim 15, wherein said accessory housing, which is made of insulated material, has a receiving cavity receiving said LED therein, a front opening communicating with said receiving cavity to mount said electrostatic probe at said front opening to contact with said first terminal of said LED, and a transparent window aligned with said LED for said light of said LED passing through said transparent window.

18. The method, as recited in claim 16, wherein said accessory housing, which is made of insulated material, has a receiving cavity receiving said LED therein, a front opening communicating with said receiving cavity to mount said electrostatic probe at said front opening to contact with said first terminal of said LED, and a transparent window aligned with said LED for said light of said LED passing through said transparent window.

19. The method, as recited in claim 11, wherein said accessory housing further comprises carrying means for said user carrying said accessory housing on a body of said user.

20. The method, as recited in claim 18, wherein said accessory housing further comprises carrying means for said user carrying said accessory housing on a body of said user.
